(19) United States
(12) Patent Application Publication
(10) Pub. No.: US 2012/0041946 A1
(43) Pub. Date: Feb. 16, 2012

(54) DATA SEARCH APPARATUS, CONTROL METHOD THEREOF AND COMPUTER READABLE STORAGE MEDIUM

(75) Inventor: Hiroto Oka, Machida-shi (JP)

(73) Assignee: CANON KABUSHIKI KAISHA, Tokyo (JP)

(21) Appl. No.: 13/188,876

(22) Filed: Jul. 22, 2011

(30) Foreign Application Priority Data
Aug. 10, 2010 (JP) 2010-179667

(51) Int. Cl. G06F 17/30

(52) U.S. Cl. 707/722; 707/780; 707/E17.014

(57) ABSTRACT

A data search apparatus for searching image data, comprising units for, storing image data in association with search information of the image data, accepting an input of a search condition of the image data, searching for image data related to the search condition using the search information, controlling a display unit to display a list of images for selecting a desired image so as to edit the search information based on the searched image data, detecting whether or not search information corresponding to each of the image data displayed on the display unit has been changed, and, determining, based on relevance between the accepted search condition and the changed search information, whether or not to notify that the change has been made for the displayed image data corresponding to the search information, wherein the change of which has been detected.

### BACKGROUND OF THE INVENTION

1. Field of the Invention

The present invention relates to a data search apparatus and a control method thereof, and a computer readable storage medium.

2. Description of the Related Art

A technique which collates previous data recorded in a database and current data, and notifies the user of changed data by highlighting them is available (see Japanese Patent Laid-Open No. 2005-250788).

### SUMMARY OF THE INVENTION

When the aforementioned technique is applied to an image browser, even when image data, which are displayed on the image browser and are indifferent ones for the user, have been changed, the image browser notifies the user of all changed data. For this reason, information that is necessary is buried, and it is not easy for the user to find such information.

According to one aspect of embodiments, the present invention relates to a data search apparatus for searching image data, comprising, a storage unit configured to store image data in association with search information of the image data, an input acceptance unit configured to accept an input of a search condition of the image data, a search unit configured to search for image data related to the search condition using the search information, a display control unit configured to control a display unit to display a list of images for selecting a desired image so as to edit the search information based on image data searched by the search unit, a detection unit configured to detect whether or not search information corresponding to each of the image data displayed on the display unit has been changed, and, a determination unit configured to determine, based on relevance between the search condition accepted by the input acceptance unit and the changed search information, whether or not to notify that the change has been made for the image data displayed on the display unit corresponding to the search information, wherein the change of which has been detected.

Another aspect of embodiments, the present invention relates to a control method of a data search apparatus for searching image data, comprising, an input acceptance step of accepting an input of a search condition of image data, a search step of searching for image data related to the search condition using search information of image data stored in a storage unit, a display control step of controlling a display unit to display a list of images for selecting a desired image so as to edit the search information based on image data searched in the search step, a detection step of detecting whether or not search information corresponding to each of the image data displayed on the display unit has been changed, and, a determination step of determining, based on relevance between the search condition accepted in the input acceptance step and the changed search information, whether or not to notify that the change has been made for the image data displayed on the display unit corresponding to the search information, wherein the change of which has been detected.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of a data search apparatus according to an embodiment;

FIG. 2 is a view showing an example of the data configuration of image data according to the embodiment;

FIGS. 3A and 3B are views showing examples of user interfaces of an image browser according to the embodiment;

FIG. 4 shows an example of the data configuration of a table of a database according to the embodiment;

FIG. 5 is a flowchart showing an example of processing according to the first embodiment;

FIG. 6 is a flowchart showing an example of change notification determination processing according to the first embodiment;

FIG. 7 is a view showing a display example of the image browser according to the first embodiment;

FIG. 8 is a view showing another display example of the image browser according to the first embodiment;

FIG. 9 is a flowchart showing an example of processing upon refreshing the image browser according to the first embodiment;

FIG. 10 is a flowchart showing an example of change notification determination processing according to the second embodiment;

FIG. 11 is a view showing an example of a user interface of a RAW development application according to the third embodiment;

FIG. 12 is a view showing an example of the system configuration according to the fourth embodiment;

FIG. 13 shows an example of the data configuration of a table of an image management database 1205 according to the fourth embodiment;

FIG. 14 shows an example of the data configuration of a table of a user management database 1206 according to the fourth embodiment; and

FIG. 15 is a flowchart showing an example of change notification determination processing according to the fourth embodiment.

### DESCRIPTION OF THE EMBODIMENTS

Embodiments of the present invention will be described hereinafter with reference to the accompanying drawings.

### First Embodiment

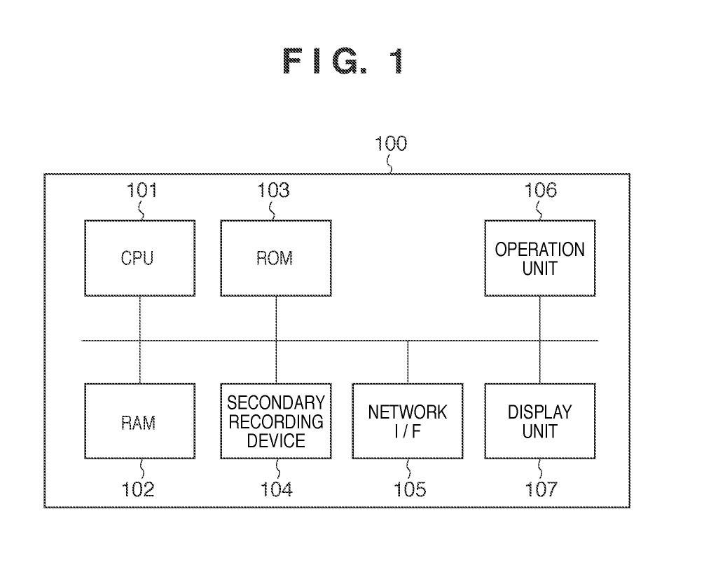

FIG. 1 is a block diagram of a data search apparatus according to this embodiment. In this embodiment, a data search apparatus is implemented in the form of an image browser application which runs on a PC (personal computer).

A PC 100 has a CPU 101, RAM 102, ROM 103, secondary recording device 104, network I/F 105, operation unit 106, display unit 107, and bus 108. The ROM 103 records a basic control program of the data processing apparatus (or PC) 100, and that program is loaded onto the RAM 102 and executed by the CPU 101 when the data processing apparatus 100 is activated. The secondary recording device 104 may be configured by a hard disk or memory disk. The secondary recording device 104 may record, for example, a high-level control program (for example, an OS), an image browser, and a database required to manage information associated with image data. Furthermore, the secondary recording device 104 may record, for example, an application required to connect a camera and to capture image data into the PC 100, and captured image data.

These software programs are loaded onto the RAM 102 and are executed by the CPU 101 as needed. The network I/F 105 can be configured as, for example, a USB interface used to connect a USB cable, and the PC 100 is connected to the camera via this interface. The operation unit 106 is configured by, for example, a keyboard and mouse which allow the user to input data to the data processing apparatus. The display unit 107 is configured by, for example, a display monitor which displays images and graphical user interface (GUI) screens. The bus 108 interconnects the blocks 101 to 107.

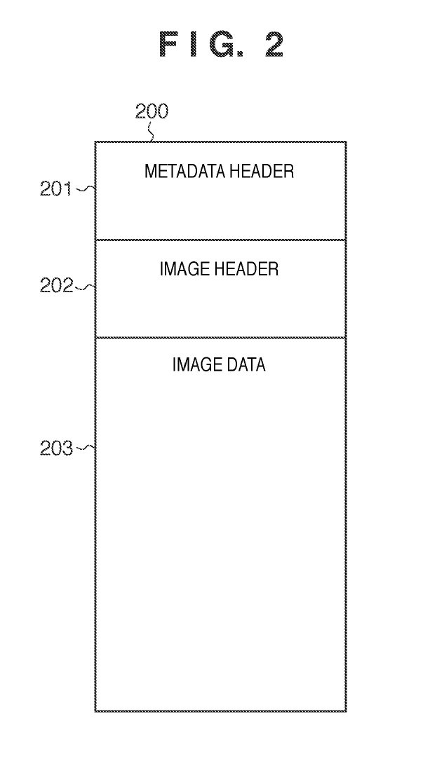

FIG. 2 is a view showing an example of the data configuration of image data used in this embodiment. Image data 200 is one file, and corresponds to one image data. An area 201 is a metadata header area which stores additional information associated with an image as metadata (search information). Metadata is defined by the standard such as Exif, and corresponds to a photographing date and time, camera parameters (for example, a focal length and zoom ratio) at the time of photographing, a rating (favorite level), image search keywords, a comment, and a thumbnail. An area 202 is a header area which stores information required to decode an image. For example, in case of a JPEG image, the area 202 stores a thumbnail image obtained by reducing an image in size. An area 203 stores actual data of an image.

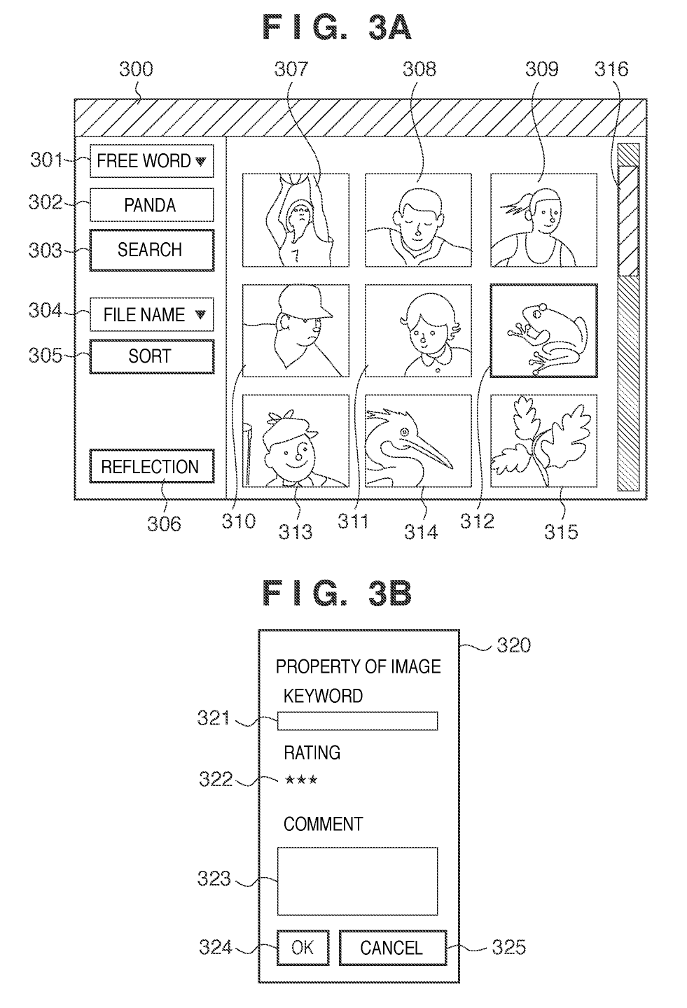

FIG. 3A shows a user interface of an image browser 300 according to this embodiment. A list box 301 accepts, from the user, designation about metadata of an image to be used as a search target (to be referred to as “search condition” hereinafter). In FIG. 3A, “free word” as a default is set as a search target. In a free word search, the image browser 300 can conduct a partial match search using, for example, a file name, keywords, and command as targets of metadata of image data. Of course, in addition to the partial match search, a search using only a comment as a target, that using a photographing date and time as a target, and that using a rating as a target can be conducted.

A text box 302 accepts, from the user, an input of a key (for example, an expression or numerical value) used in a search. For example, when the user designates “free word” in the box 301 and “panda” in the box 302, the image browser 300 searches for images which include an expression “panda” in any of file names, keywords, and comments. A button 303 is used to accept a search start instruction from the user. A technique for searching for and displaying data in a database in the secondary recording device 104 is known, and a description thereof will not be given.

A list box 304 accepts, from the user, designation about metadata of an image used to execute sorting as processing for changing a display order of a thumbnail list (to be referred to as “sort condition” hereinafter). FIG. 3A exemplifies a case in which thumbnails are sorted and displayed using “file name” as a default. Of course, in addition to “file name”, for example, a photographing date and time and file update date and time can be designated as the sort condition. Also, an ascending or descending order can be designated. When the user issues a search instruction, the image browser 300 conducts a search, and sorts and displays search results using the sort condition. When the user wants to change the sort condition, he or she need only set a sort condition in the list box 304, and press a button 305. A button 306 is a reflection button, and its function will be described in detail later.

Thumbnails 307 to 315 correspond to a list of images retrieved by the image browser 300. When the number of thumbnails is too large not to fall within the window, the image browser 300 displays a scroll bar 316. When the user wants to view an image in its original size, he or she double-clicks a thumbnail image. Then, the image browser 300 opens another window to display the image of the original size.

When the user wants to display or edit metadata of an image, he or she clicks a right button of a mouse on a thumbnail image, and selects “property of image” from a context menu (not shown). Then, the image browser 300 displays a property dialog 320 shown in FIG. 3B. For the sake of simplicity, this embodiment shows a case in which three metadata, that is, a keyword, rating, and comment can be displayed and edited. Of course, other metadata of a table 401 may also be changed. A keyword setting/display field 321 is used to display and edit one or a plurality of keywords. A rating setting/display field 322 is used to display and edit a rating, and allows the user to set a rating using zero to five stars. An image which is not set with a rating since it is just captured from the camera has a rating “none”. A comment setting/display field 323 is used to display and edit a comment. An OK button 324 is pressed when the user wants to change a property by the contents input in the respective setting/display fields. A cancel button 325 is pressed when the user wants to cancel a property change operation.

The image browser 300 uses a database in the secondary recording device 104 so as to manage metadata of images. Using the database, a quick search using metadata as a search condition can be conducted. Since a technique for reading out metadata from image data, and recording them in the database is known, a description thereof will not be given. Of course, metadata may be managed by writing and reading out them in and from a file without using the database.

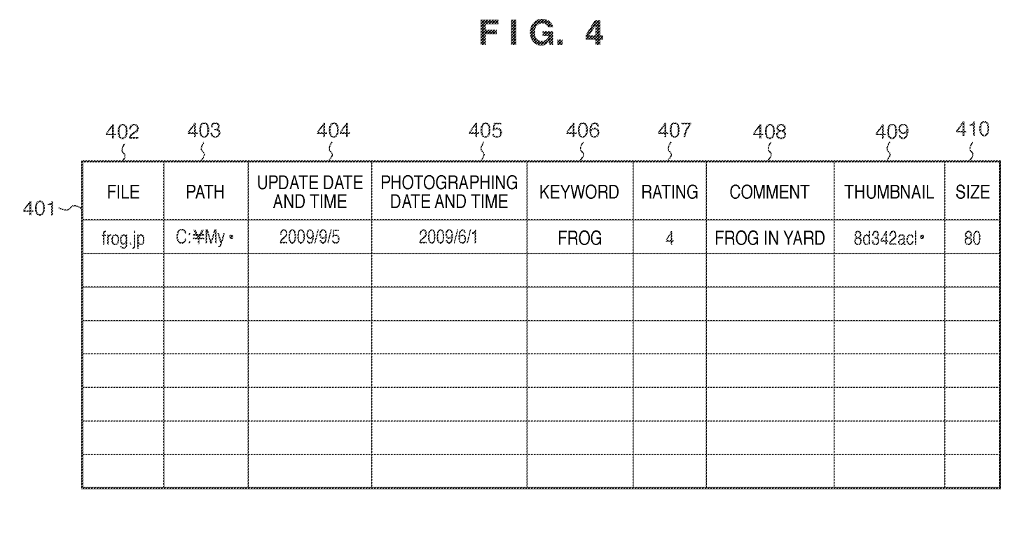

FIG. 4 shows an example of the configuration of a table of a database used in this embodiment. This table is used to integrally manage image data and their metadata. For the sake of simplicity, assume that metadata are managed using a single table 401, and metadata which are not written in FIG. 4 are not handled. Metadata, which can be used in practice although they are not described in FIG. 4, include position information and face information, and additional metadata may be further prepared. This table 401 can store image data stored in the secondary recording device 104 in association with metadata as search information of these image data.

A file 402 indicates a file name of image data. A path 403 stores a file path which indicates a location of image data in the database of the secondary recording device 104. An update date and time 404 represents a last update date and time of an image file. A photographing date and time 405 represents a date and time of an image photographed by the camera. When image data is not photographed by the camera, this item records the aforementioned update date and time instead. A keyword 406 is a keyword for a search. A plurality of keywords can be set. A rating 407 represents a rating set by the user, and records a value ranging from 0 to 5 or a value “none”. The value “none” is a state before the user decides a rating after photographing of an image. A comment 408 indicates a comment created by the user. A thumbnail 409 records that of an image in a JPEG format. The number of pixels of the thumbnail is described in a header of thumbnail data. A size 410 is a data size of the thumbnail.

The image browser 300 has a notification function. When the user conducts a search, as shown in FIG. 3A, the image browser 300 displays search results in the form of a thumbnail list. After that, when the user modifies metadata of an image using the property dialog 320, the image browser 300 highlights the corresponding thumbnail so as to notify the user that the metadata of the image have been changed. In this embodiment, as exemplified on the thumbnail 312 in FIG. 3A, a bold frame is displayed. Of course, other highlight methods may be used. For example, a frame color of a thumbnail may be changed, an icon may be attached, a thumbnail may be flickered, or a thumbnail may be displayed on an independent window.

At this time, in the related art, the following problem is posed. For example, a case will be examined below wherein the user connects a digital camera to the PC 100 installed with the image browser 300, imports several just photographed images to the PC 100, and sets ratings of these images using the image browser 300. Since the just photographed images have a rating “none”, the user searches for images with a rating “none” by designating “rating” as a search condition. Next, the user opens the property dialog 320 for each thumbnail of the thumbnail list displayed as search results, and sets a rating by operating the rating setting/display field 322. During this operation, the user is likely to write a comment in the comment setting/display field 323. As described above, a thumbnail of an image, the rating or comment of which has been changed, is highlighted by the notification function. Assume that the user completes this operation, and all thumbnails displayed on the image browser 300 have a state like the thumbnail 312.

In this case, assume that the user forgets to set a rating, and writes only a comment in a certain thumbnail. However, the user can recognize this fact from the screen of the image browser 300. As a result, this user interface confuses the user.

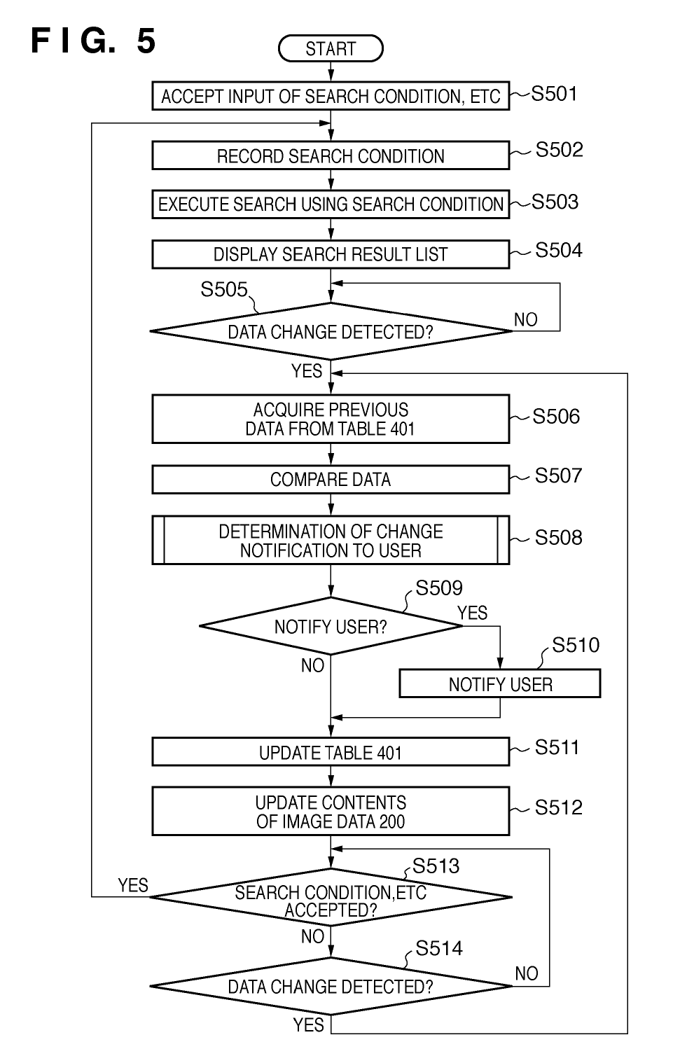

Hence, the image browser 300 according to this embodiment operates according to the flowchart shown in FIG. 5. Processing corresponding to this flowchart is implemented when the CPU 101 reads out a predetermined program including the image browser application stored in the secondary recording device 104 onto the RAM 102, and executes the readout program.

In step S501, inputs of a search condition and search key from the user are accepted via the image browser 300. In this case, an input for a sort condition can also be accepted using the list box 304. After the latest search condition is recorded in the RAM 102 in step S502, the CPU 101 conducts a search of the table 401 in the secondary recording device 104 in step S503. In step S504, the CPU 101 executes display control for displaying a list of thumbnails of images obtained as search results on the display unit 107 using the image browser 300. The process advances to step S505, and the CPU 101 detects whether a searched image or its metadata has been changed. As a detection method, whether or not the user has pressed the OK button 324 can be detected using the property dialog 320 shown in FIG. 3B. When another application or a shell of the OS has directly changed an image data file, the CPU 101 may receive and detect information “a file has been changed” (such case will be described later in the third embodiment).

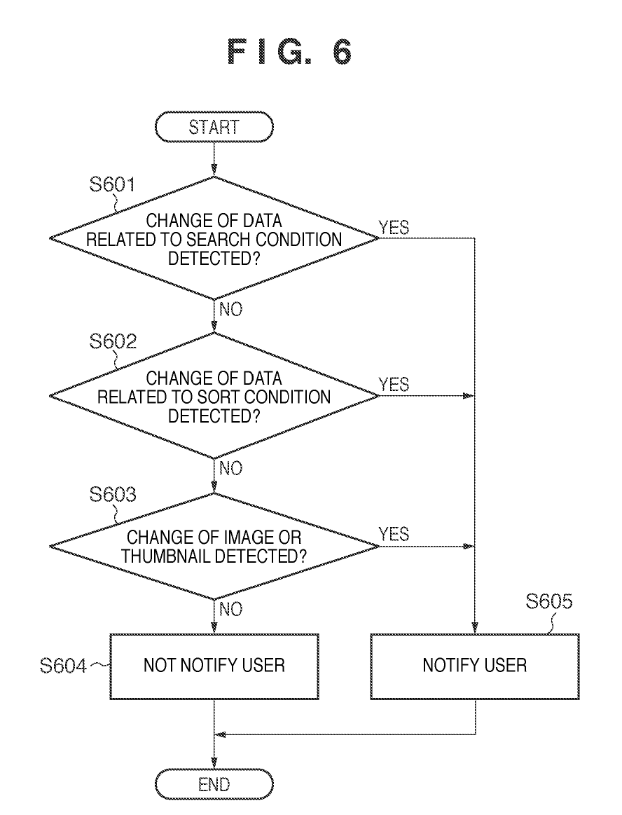

If no change is detected, the process returns to step S505. If a change is detected, the process advances to step S506, and the CPU 101 acquires previous metadata of the image of interest from the table 401. In step S507, the CPU 101 compares information of metadata accepted via the property dialog 320 with that of the acquired previous metadata to determine which metadata have been changed. The process advances to step S508, and the CPU 101 determines based on types of the changed metadata whether or not to notify the user of the change. The processing in step S508 will be described in detail later with reference to FIG. 6. The process then advances to step S509. If it is determined in step S508 that the image browser notifies the user of the change, the CPU 101 executes display control of the display unit 107 to notify the user of the change in step S510. The notification is made by displaying a bold frame of a thumbnail, as described above. The process advances to step S511, and the CPU 101 updates the table 401 based on the contents of the metadata accepted via the property dialog 320.

The image browser acquires the contents of the metadata updated in this step as previous metadata from the database in step S506 when the same image file is changed for the next time. In step S512, the CPU 101 changes the contents of a body of the corresponding image data. That is, the CPU 101 updates metadata in the header 201 and a thumbnail image in the header 202. The process then advances to step S513, and the CPU 101 determines whether or not an input of, for example, a search condition is accepted again from the user. If the input is accepted again, the process returns to step S501. On the other hand, if no input is accepted, the process advances to step S514 to detect a change of an image or metadata. If no change is detected, the process returns to step S513; otherwise, the process returns to step S506 to repeat the processing.

Note that the image browser 300 acquires previous metadata from the table 401 of the database in step S506. Alternatively, the image browser 300 may acquire previous metadata from the RAM 102 in place of the database. In this case, even after the contents of metadata accepted via the property dialog 320 are written in the table 401 in step S511, they may be kept held in the RAM 102.

The processing in step S508 above will be described in detail below using the flowchart of FIG. 6. In step S601, the CPU 101 determines the relevance between the search condition and changed search information by checking based on the comparison result in step S507 whether or not metadata related to the search condition has been changed. If metadata related to the search condition has been changed, the process advances to step S605 to decide that the image browser 300 notifies the user of the change. The metadata related to the search condition includes, for example, a file name, keyword, and comment when the search condition is “free word”. Also, such metadata includes a rating when the search condition is “rating”. If such metadata has not been changed, the process advances to step S602, and the CPU 101 determines the relevance between the sort condition and the changed search information by determining based on the comparison result in step S507 whether or not metadata related to the sort condition has been changed. The sort condition includes, for example, an update date and time, photographing date and time, and file name. Hence, the CPU 101 determines whether or not metadata corresponding to such sort condition has been changed. If the metadata related to the sort condition has been changed, the process advances to step S605. If such metadata has not been changed, the process advances to step S603 to determine whether or not an image itself or thumbnail has been changed. Whether or not an image has been changed can be determined by seeing whether or not a path has been changed or whether or not a file format has been changed, as will be described in the third embodiment. Whether or not a thumbnail has been changed can be determined by seeing whether or not data itself or a size has been changed. If the image or thumbnail has been changed, the process advances to step S605; otherwise, the process advances to step S604 to decide that the image browser 300 does not notify the user of the change.

With the above processing, when metadata, which is interested in by the user and is related to the search condition, has been changed, the image browser 300 notifies the user of the change. Also, when metadata related to the sort condition has been changed, since an order of the thumbnail list is likely to be changed, the image browser 300 notifies the user of the change. Since an image and thumbnail are most important data of image data, the image browser 300 also notifies the user of the change of the image or thumbnail when it has been changed.

Of course, as another embodiment, when metadata related to the sort condition has been changed, the image browser 300 may operate not to especially notify the user of the change. Alternatively, the user may set metadata of interest (for example, a comment) in advance, and the image browser 300 may notify the user of the change when that metadata has been changed.

In this case, the reason why a description “related to” the search condition is made is that the search condition need not always be the same as the changed metadata. For example, when the user designates “free word” as the search condition, the image browser 300 searches and acquires images in each of which any of a keyword, comment, and file name partially matches an expression designated by the user. At this time, when a comment of a certain image has been changed, the image browser 300 notifies the user of that change. As another example, when image data does not include any photographing date and time, as described above, the image browser 300 uses the update date and time of a file in place of the photographing date and time. In this case, assume that the user designates a photographing date and time as the search condition. Even when the update date and time of an image which does not include any photographing date and time has been changed, the image browser 300 notifies the user of that change.

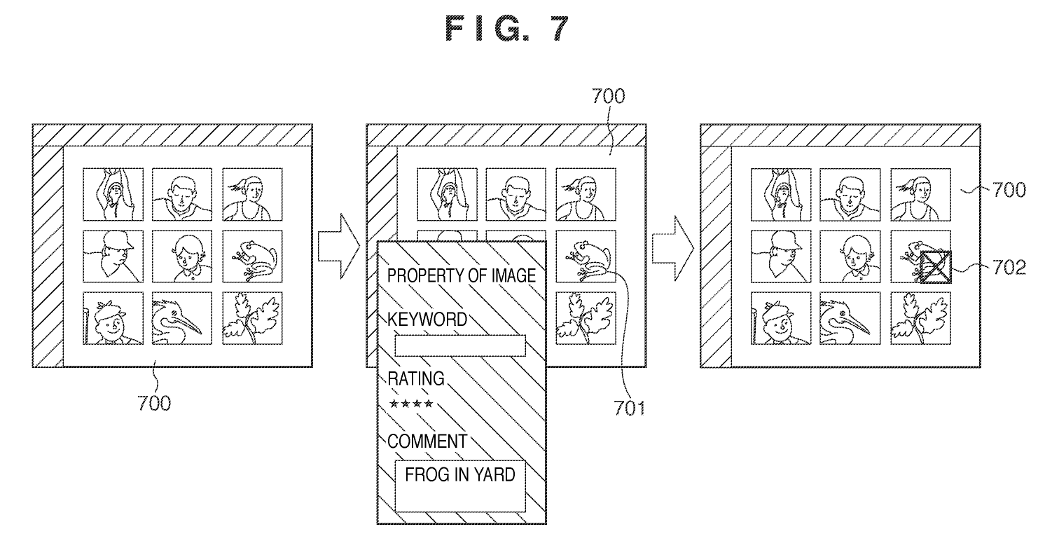

As shown in FIG. 7, depending on the search condition and the change contents of metadata, a thumbnail whose metadata has been changed may often be excluded from the thumbnail list display of search results. For example, when the user wants to search for images having a rating “3”, the image browser 300 acquires images having a rating “3” from the table 401, and displays the thumbnail list like a screen 700. In this case, when the user changes the rating of an image 701 to “4”, that image is no longer be displayed in the list when a next search is conducted using the same condition. Hence, the image browser 300 displays an icon 702 indicating that the image disappears from the list on the screen 700 to notify the user of that fact. Of course, the image browser 300 may notify the user of the fact by a method of changing a frame color of a thumbnail or displaying a translucent thumbnail in place of the icon.

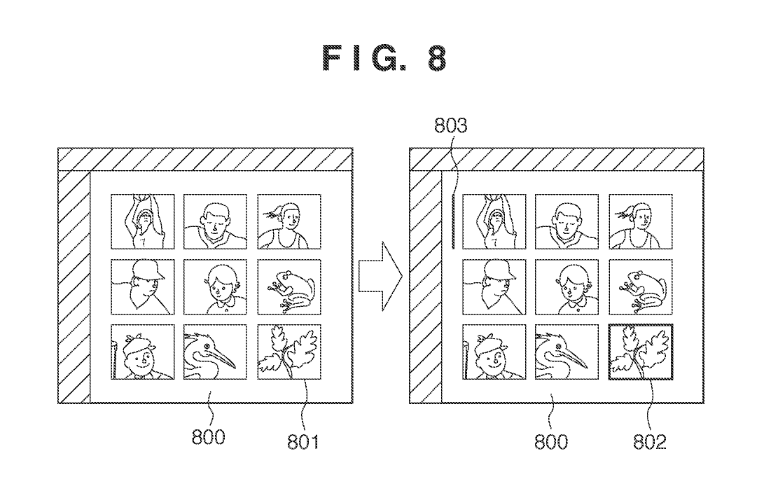

Also, as shown in FIG. 8, depending on the sort condition and the change contents of metadata, a thumbnail may be moved on the thumbnail list. For example, assume that the image browser 300 sorts search results using file names, and displays thumbnails in that order, as shown in a screen 800. Then, assume that the user changes a name of an image 801 from “zzz.jpg” to “aaa.jpg” using, for example, a function of the OS. In this case, when the user conducts a search using the same condition, and sorting is executed again based on file names, the image 801 is displayed at a head position of the thumbnail list. Hence, the image browser 300 may notify the user that the display position of that thumbnail will be changed, prior to execution of an actual search. For example, after the user changes the file name of the image 801, as described above, and then moves a mouse cursor on the image 801, the image browser 300 highlights the image 801, as denoted by reference numeral 802. Alternatively, the image browser 300 may display a move destination of the image 801, as denoted by reference numeral 803.

As described above, when metadata of an image have been changed, the image browser 300 displays various kinds of information indicating these changes. Hence, the image browser 300 reflects these pieces of information to the thumbnail list at a certain timing, and refreshes the screen. In this embodiment, the image browser 300 refreshes the screen at a pressing timing of the reflection button 306 shown in FIG. 3A by the user.

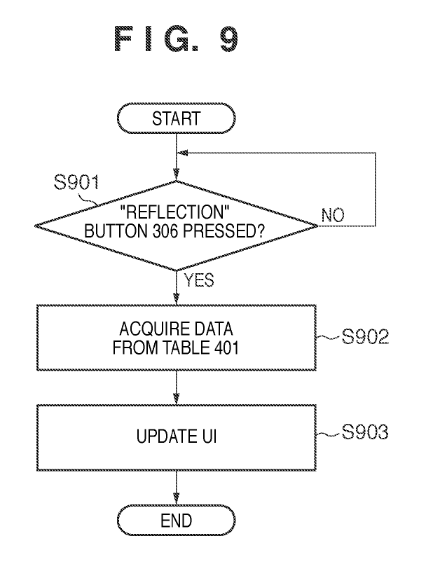

The refresh operation will be described below using the flowchart of FIG. 9. The CPU 101 determines in step S901 whether or not the user has pressed the reflection button 306. If NO in step S901, the process returns to step S901. If YES in step S901, the process advances to step S902. Since the image browser 300 has recorded the latest information in the table 401 of the database in step S511 in the flowchart of FIG. 5, it acquires that information in step S902. Then, the process advances to step S903 to update the thumbnail list.

The refresh timing may be a timing at which the user quits the image browser 300 and then restarts it. Alternatively, the refresh timing may be a timing at which the user conducts a search again. Alternatively, the screen may be refreshed every time metadata and thumbnails have been changed a predetermined number of times or after an elapse of a predetermined time period.

In the above description, the image browser 300 simply highlights a thumbnail corresponding to a changed image or metadata when it notifies the user of a change of the image or thumbnail. However, the image browser 300 may notify the user how metadata has been changed using, for example, a popup window. Alternatively, the image browser 300 may display metadata before and after the change. Furthermore, the image browser 300 may manage change histories and change times using a database, and may display them.

As described above, only when an image or thumbnail, or metadata of interest has been changed, the image browser 300 notifies the user of that change, and the user can obtain necessary information in an easily understood manner.

Hence, even in the above situation in which the user forgets to set a rating and writes only a comment for a certain thumbnail, if the search condition is “rating”, an image in which the rating is not changed, and only the comment has been changed is not highlighted. Hence, the user can immediately recognize the image for which he or she forgets to set a rating.

### Second Embodiment

The image browser described in the first embodiment acquires a thumbnail list of search results by searching the database using the search condition, then detects a change of metadata related to the search condition, and notifies the user of that change. This embodiment will explain an image browser which records a history of search conditions, and notifies the user when metadata related to any of the recorded search conditions has been changed.

As in the first embodiment, the image browser to be described in this embodiment is implemented as an application which runs on a PC. Since a block diagram of the PC is the same as that shown in FIG. 1 of the first embodiment, a description thereof will not be repeated. Also, since a user interface of the image browser to be described in this embodiment is also the same as that shown in FIG. 3A of the first embodiment, a description thereof will not be repeated.

The operation of the image browser to be described in this embodiment will be described below using flowcharts. Since this operation is nearly the same as that of the image browser described in the first embodiment, differences will be mainly described using FIG. 5.

In step S502, a CPU 101 records an input search condition in a RAM 102. In this case, unlike in the first embodiment which records only the latest search condition, the CPU 101 records previous search conditions in the RAM 102 as a history. This history may be erased when the image browser is quitted. Alternatively, the history may be recorded in a table 401 of a database or in a header 201 of image data 200 so as not to be erased even after the image browser is quitted. If the image browser runs on a Windows® OS, the CPU 101 may record the history in a registry.

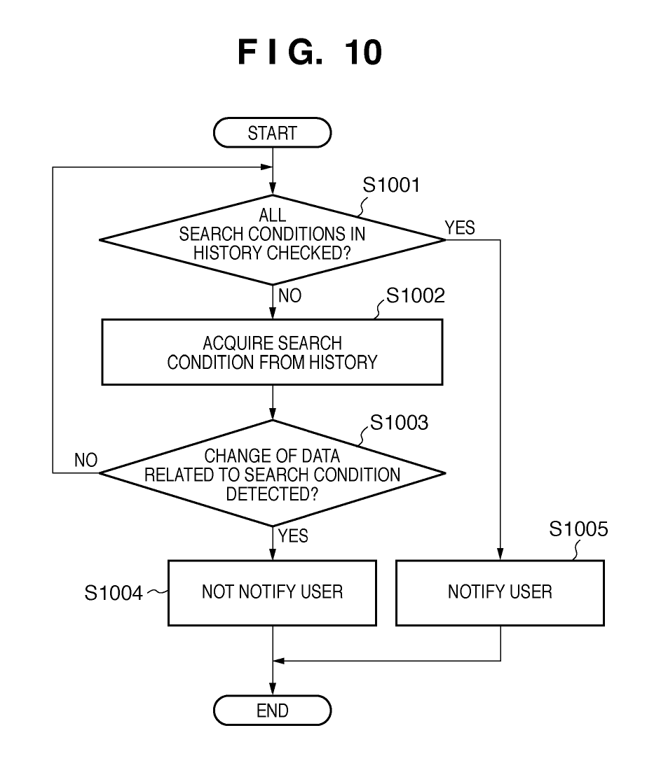

Also, since the processing in step S508 is different from the first embodiment, it will be described in detail below with reference to FIG. 10. The CPU 101 checks in step S1001 whether or not all the search conditions recorded as the history are used in determination. If search conditions to be used in determination still remain, the process advances to step S1002 to acquire a search condition from the history. The process advances to step S1003 to determine whether or not metadata related to the acquired search condition has been changed. For example, when “free word” or “rating” is designated as the search condition of the history, the CPU 101 determines whether or not metadata related to such search condition has been changed. If the metadata has been changed, the process advances to step S1004 to decide that the image browser notifies the user of that change. If the metadata has not been changed, the process returns to step S1001. If it is judged in step S1001 that all the search conditions in the history are used in determination, the process advances to step S1005 to decide that the image browser does not notify the user of the change.

In the above example, as a condition used to determine whether or not the image browser notifies the user of the change, only the history of the search conditions is used. However, as described in the first embodiment, the determination may be made using a sort condition, or it may be decided that the image browser notifies the user of the change when an image or thumbnail has been changed.

In the above description, the image browser manages all search conditions used in searches as the history. However, other methods may be used. For example, a search condition after an elapse of a predetermined time period or the predetermined number of search times since it was registered in the history may be erased. Alternatively, how many times each individual search condition was used in searches may be counted, and only a search condition which was used a predetermined number of times or more may be used in determination. Thus, a search condition which is not frequently used by the user (about which the user is indifferent) may be excluded from the user notification determination. Alternatively, a search history (which may be either the search conditions or the search conditions and the number of images retrieved by searches) may be presented to the user, and the image browser may prompt the user to select a search condition to be used in determination.

As described above, when a plurality of types of metadata of interest have been changed, the image browser 300 notifies the user of such changes, and the user can obtain necessary information in an easily understood manner.

### Third Embodiment

The first embodiment has mainly explained the operation of the image browser when the user has changed metadata of an image using the image browser. However, in practice, the user may often change metadata of an image using an application other than the image browser or a shell of an OS. Alternatively, when image data files are stored in, for example, a file server, users other than the user of the image browser may change metadata of an image using applications including the image browser or a shell of the OS. Furthermore, an application or service which runs in the background may change metadata of an image. Hence, this embodiment will demonstrate that the present invention is effective even in the aforementioned cases.

This embodiment will examine an example in which the user uses a RAW development application in addition to the image browser.

The RAW development application is used to convert a file format of data which is just obtained from an image sensing element (RAW image) into, for example, JPEG image data after the user sets various development parameters for the RAW image (such processing will be referred to as development hereinafter). The development parameters include a color temperature, saturation, color tone, exposure, contrast, and tone curve. The RAW development application runs as an application of a PC in the same manner as the image browser. Since a block diagram of the PC is the same as that shown in FIG. 1 of the first embodiment, a description thereof will not be repeated.

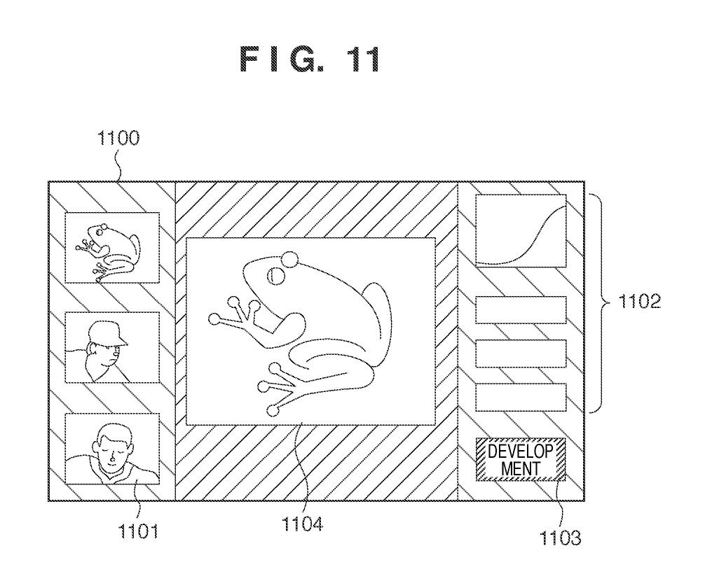

FIG. 11 shows a user interface of the RAW development application used in this embodiment. A screen 1100 is an example of a display screen of the RAW development application. On an area 1101, thumbnails of a plurality of RAW images are displayed, and the RAW development application executes development processing of a RAW image selected by the user from these thumbnails. A user interface 1102 accepts a user instruction so as to set the aforementioned development parameters. In this embodiment, since a development parameter setting method is not so important, a detailed description thereof will be skipped. A development button 1103 is used to accept a user's development start instruction. An image 1104 is an example of an image after development. The development requires a time period of about several ten seconds. After completion of the development, the RAW development application waits for a user's image save instruction, and then saves the image data as a file.

The operation of an image browser 300 of this embodiment will be described below using the flowchart. Since this operation is nearly the same as that of the image browser 300 described in the first embodiment, differences will be mainly described using FIG. 5.

A CPU 101 executes processes in steps S501 to S504 based on user operations. The CPU 101 determines in step S505 whether or not a searched image or its metadata has been changed. As this determination method, some methods may be used. When a file or folder has been changed, some OSs have a function of notifying an application of that file or folder name and change contents. For example, a Windows® OS has this function. In this case, the image browser can conduct a prefix search to have a file path (a path 403 in FIG. 4) of image data files using a file or folder path name notified by the OS, and can acquire data of found images in step S506. In this embodiment, the invention is carried out using this detection method.

As another detection method, after the RAW development application saves image data, it may notify the image browser that the image data has been changed using an inter-process communication. Alternatively, as still another detection method, the image browser checks update dates and times of image data files of images displayed in a search result list at given time intervals, and if an update date and time has been changed, the image browser judges that the image data has been changed.

Referring back to FIG. 5, a case will be examined below wherein the user launches the RAW development application 1100 in a situation in which the CPU 101 detects data changes in step S505. Assume that the user selects a RAW image corresponding to one image included in the thumbnail list of the image browser 300, and applies RAW development to that image after he or she adjusts the development parameters. The user saves a JPEG image data file as the development result. Then, the image browser 300 receives, from the OS, a notification indicating that the image data file has been changed, as described above. The CPU 101 detects a data change based on this notification. Then, the process advances to step S506, and the CPU 101 searches a table 401 of a database using the file name notified by the OS as a key. Then, the process advances to step S507.

Subsequent processes are basically the same as those in the first embodiment, but update processing of image data 200 in step S512 may be skipped. This is because the image data itself has already been updated by the RAW development application.

As described above, even when an image or thumbnail, or metadata has been changed by another application or the OS, the image browser notifies the user only when metadata of interest has been changed. Therefore, the user can obtain necessary information in an easily understood manner.

### Fourth Embodiment

The first to third embodiments have explained the case in which the data search apparatus is a standalone apparatus, that is, the example in which images as search targets are recorded in a user PC 100 and a secondary recording device 104 connected to the user PC. By contrast, this embodiment will explain a case in which the data search apparatus is implemented as a search server on the Internet. As will be understood from a description of this embodiment, the present invention is also effective when a search is conducted for images on a network.

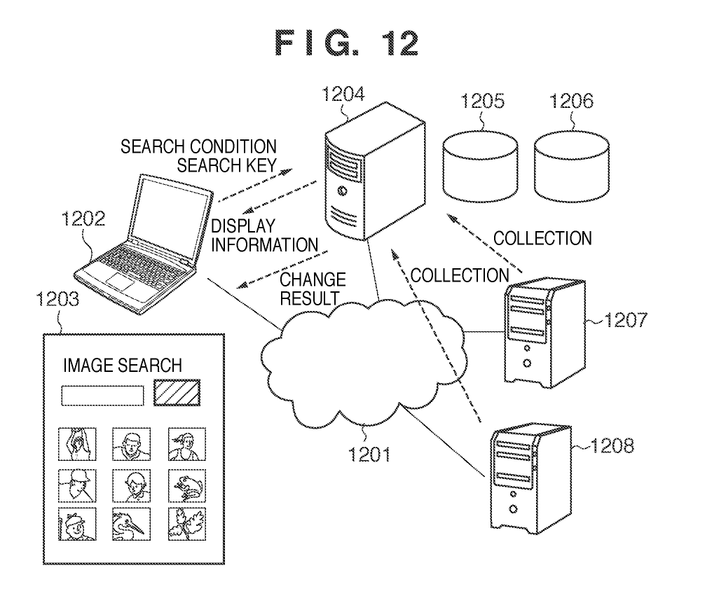

FIG. 12 is a view showing an example of the system configuration established via the Internet in this embodiment. To an Internet 1201, a PC 1202, search server 1204, and Web servers 1207 and 1208 are connected. On the PC 1202, a Web browser 1203 is running. The search server 1204 incorporates functions corresponding to the present invention. To the search server 1204, an image management database 1205 and user management database 1206 are connected. FIG. 12 shows the example of the system configuration including the two Web servers, but a large number of Web servers are connected in practice. Since a block diagram of each of the PC 1202, search server 1204, and Web servers 1207 and 1208 is the same as that shown in FIG. 1 of the first embodiment, a description thereof will not be repeated. Note that a network I/F 105 in each apparatus includes a communication interface required to establish a connection to the Internet.

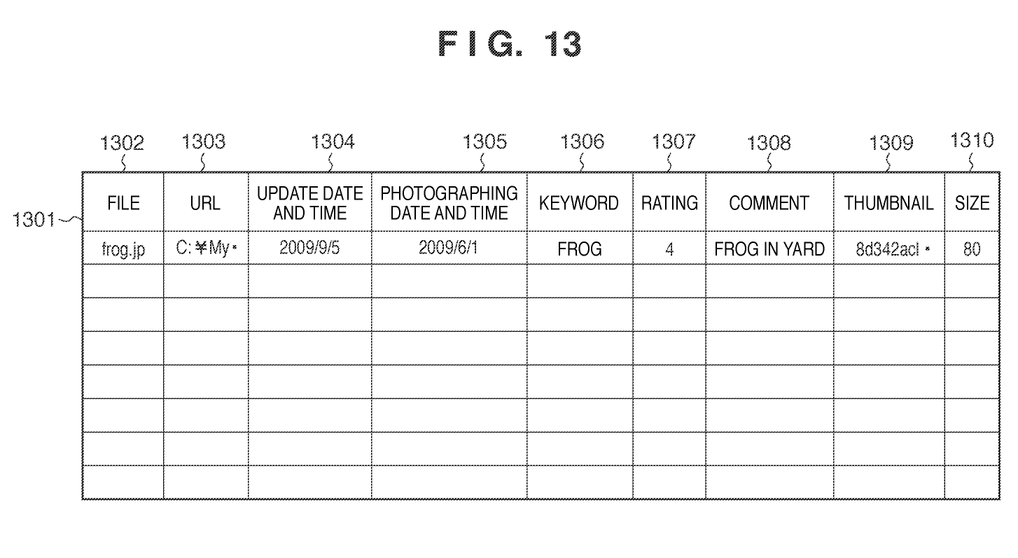

An example of the table configuration of the image management database 1205 will be described below with reference to FIG. 13. For the sake of simplicity assume that metadata are managed using a single table, and metadata which are not written in FIG. 13 are not handled. Metadata, which can be actually used although they are not described in FIG. 13, include position information and face information.

In a table 1301, a file 1302 indicates a file name of image data. A URL 1303 indicates a URL of a save destination of image data. An update date and time 1304 represents a last update date and time of an image file. A photographing date and time 1305 represents a date and time of an image photographed by a camera. When image data is not photographed by the camera, this item records the aforementioned update date and time instead. A keyword 1306 is a keyword for a search. A plurality of keywords can be set. A rating 1307 represents a rating set by the user, and records a value ranging from 0 to 5 or a value “none”. The value “none” is a state before the user decides a rating after photographing of an image. A comment 1308 indicates a comment created by the user. A thumbnail 1309 records that of an image in a JPEG format. The number of pixels of the thumbnail is described in a header of thumbnail data. A size 1310 is a data size of the thumbnail.

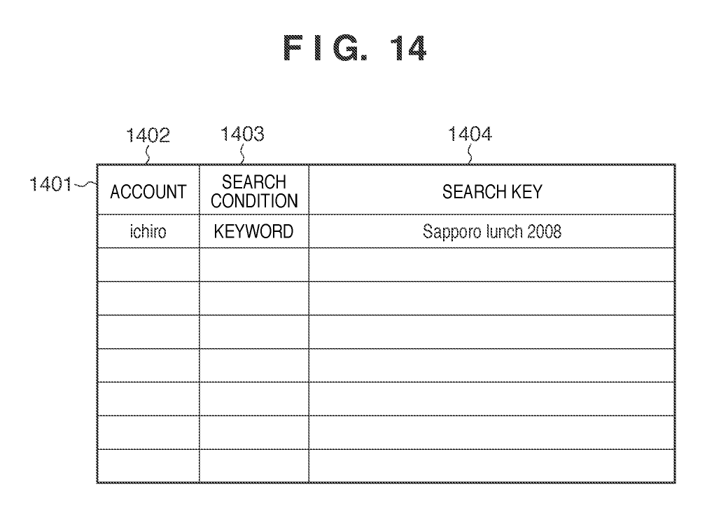

An example of the table configuration of the user management database 1206 will be described below with reference to FIG. 14. In a table 1401, an account 1402 represents an account name assigned to each user. A search condition 1403 represents a search condition used by the user in a search. A search key 1404 includes an expression or numerical value used in a search, and can record one or a plurality of search keys.

The operation of the search server 1204 according to the embodiment of the present invention will be described below. The search server simultaneously accepts requests from a plurality of PCs in practice. However, this embodiment will explain a case in which only the specific PC 1202 is to be handled, for the sake of simplicity. The processing of this embodiment will be described below with reference to FIG. 5. The processing in this case is implemented when a CPU 101 of the search server 1204 reads out a predetermined program stored in a secondary recording device 104 onto a RAM 102, and executes the readout program.

In step S501, the search server 1204 uniquely identifies the user based on information transmitted from the PC 1202, and accepts inputs of a search condition and search key from the user. In order to identify the user, a login request to a search service may be permitted using an account name and password transmitted from the PC 1202, or a cookie may be used. Alternatively, the search server 1204 may communicate with the Web browser 1203 to give information required to identify the user. In step S502, the search server 1204 records the input search condition and search key in the user management database 1206. Before registration in the user management database 1206, the search server 1204 may temporarily store the input search condition and search key in the RAM 102 in itself.

The search server 1204 uses the user management database 1206 to record the user and the search condition used by the user to conduct a search. The process advances to step S503, and the search server 1204 searches the table 1301 of the image management database 1205 using the search condition and search key accepted in step S501, and acquires search results. The process advances to step S504, and the search server 1204 transmits thumbnails and URLs of images obtained as the search results to the PC 1202 as display information. The PC 1202 displays a list of thumbnails based on the received display information on an image browser 300, as shown in FIG. 3A.

The process then advances to step S505 to detect if an image and metadata have been changed. More specifically, the search server 1204 cruses Web pages published by Web servers represented by the Web servers 1207 and 1208 using software called a robot or search robot. Since a technique associated with the robot is known, a detailed description thereof will not be given. When the search server 1204 finds an image file, it acquires an update date and time of that file, and collates it with an update date and time which was recorded in the image management database 1205 when that image file was previously found. If the update date and time has been updated, the search server 1204 determines that it detects a change. If no change is detected, the process returns to step S505.

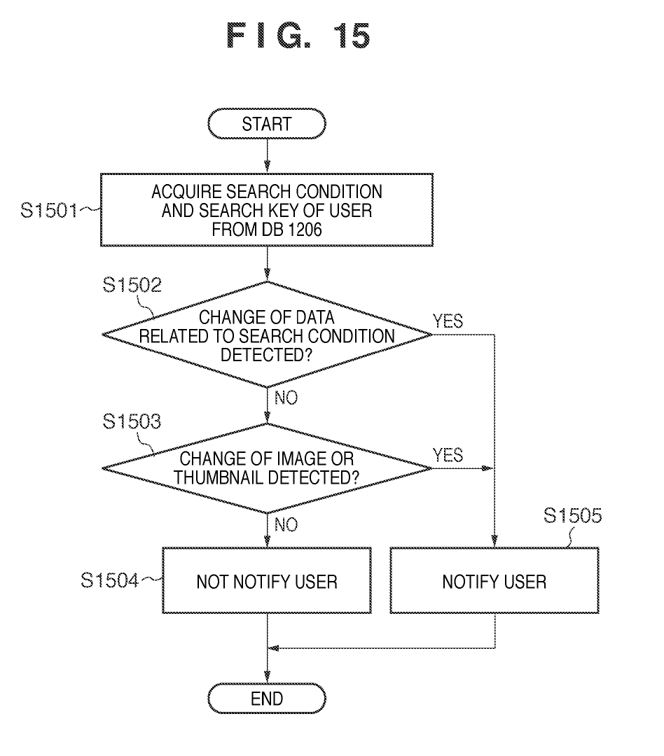

If the change is detected, the process advances to step S506, and the search server 1204 acquires previous metadata associated with the previously acquired image from the table 1301 of the image management database 1205. The process advances to step S507, and the search server 1204 acquires an image file and creates a thumbnail. After that, the search server 1204 extracts current metadata and compares them with the previous metadata, thus checking which metadata have been changed. The process advances to step S508, and the search server 1204 determines whether or not it notifies the user of the change. Details of this determination processing will be described later with reference to FIG. 15. The process advances to step S509, and if it is decided that the search server 1204 notifies the user of the change, the search server 1204 transmits updated information to the PC 1202 in step S510. The Web browser 1203 changes the thumbnail list based on the updated information received by the PC 1202. This function may be incorporated in the Web browser itself or may be incorporated in the form of a plug-in of the Web browser.

In step S511, the search server 1204 records the metadata acquired in step S507 and the created thumbnail in the image management database 1205. In step S512, the search server 1204 does not execute any special processing in this embodiment. The process advances to step S513, and the search server 1204 determines whether or not a new search condition and the like are received from the PC 1202. If a new search condition and search key are accepted, the process returns to step S502 to continue the processing. On the other hand, if no new search condition is received, the process advances to step S514. In this step, the search server 1204 executes the same processing as in step S505, and if an image and metadata have been changed, the process returns to step S506. If no change is detected, the process returns to step S513.

Details of the determination processing of the search server 1204 in step S508 will be described below with reference to the flowchart of FIG. 15. In step S1501, the search server 1204 acquires the search condition and search key of the user from the user management database 1206. The search server 1204 determines in step S1502 based on the comparison result in step S507 whether or not metadata related to the search condition has been changed. In this case, the metadata related to the search condition is the same as that in the first embodiment. If the metadata has been changed, the process advances to step S1505 to decide that the search server 1204 notifies the user of the change. If the metadata has not been changed, the process advances to step S1503 to determine whether or not an image or thumbnail has been changed. If the image or thumbnail has been changed, the process advances to step S1505; otherwise, the process advances to step S1504 to decide that the search server 1204 does not notify the user of the change.

The operation of the search server 1204 when the user designates arbitrary metadata as a search condition has been described. Therefore, when the user conducts a keyword search of images, a search is conducted to have keywords appended to images as search targets. As another method, the search server 1204 searches for Web pages including the keyword input by the user, and may return images placed on these pages to the Web browser 1203.

In the above example, when the URL of an image has been changed, it is determined that the image has been changed. Alternatively, after an image size or a byte sequence of an image is checked, it may be determined that the image has been changed. In the above example, the number of keywords used by the user in a search and the number of images obtained as search results are not limited, but upper limits may be set for them.

In this embodiment, the PC 1202 and Web browser 1203 are always active, and can communicate with the search server 1204 for the sake of simplicity. However, in a practical case, the power switch of the PC 1202 may be OFF or the Web browser 1203 may be inactive. In such case, when transmission of information has failed, the search server 1204 may transmit information again after an elapse of a predetermined time period or may transmit information when a next connection from the Web browser 1203 is established.

As described above, even when the user conducts a search for images on the network, only when an image or thumbnail, or metadata of interest has been changed, the search server 1204 notifies the Web browser 1203 of the change, and the user can obtain necessary information in an easily understood manner.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-179667, filed Aug. 10, 2010, which is hereby incorporated by reference herein in its entirety.

What is claimed is:

1. A data search apparatus for searching image data, comprising:
a storage unit configured to store image data in association with search information of the image data;
an input acceptance unit configured to accept an input of a search condition of the image data;
a search unit configured to search for image data related to the search condition using the search information;
a display control unit configured to control a display unit to display a list of images for selecting a desired image so as to edit the search information based on image data searched by said search unit;
a detection unit configured to detect whether or not search information corresponding to each of the image data displayed on the display unit has been changed; and
a determination unit configured to determine, based on relevance between the search condition accepted by said input acceptance unit and the changed search information, whether or not to notify that the change has been made for the image data displayed on the display unit corresponding to the search information, wherein the change of which has been detected.

2. The apparatus according to claim 1, wherein when a type of search information to be referred to when said search unit conducts a search based on the search condition accepted by said input acceptance unit matches a type of the changed search information, said determination unit determines that the change is notified, and when the two types do not match, said determination unit determines that the change is not notified.

3. The apparatus according to claim 1, wherein when said determination unit determines that the change is notified, said display control unit controls the display unit to display information indicating that the change has been detected on a display of search results.

4. The apparatus according to claim 1, wherein said input acceptance unit further accepts an input of a sort condition for deciding a display order of image data displayed as search results on the display unit, and
when said detection unit detects that the search information has been changed, and when search information, which is to be referred to upon deciding a display order of image data to be displayed as search results based on the sort condition accepted by said input acceptance unit, has been changed, said determination unit further determines that the change is notified.

5. The apparatus according to claim 4, wherein when said determination unit determines that the change is notified in association with the sort condition,
said display control unit controls the display unit to further display on a display of search results a display position of corresponding image data after the change of the search information, prior to re-execution of sorting based on that sort condition.

6. The apparatus according to claim 1, wherein said detection unit further detects a change of image data included in search results or of a thumbnail image corresponding to the image data, and
when said detection unit detects the change of the image data or the thumbnail image, said determination unit determines that the change is notified.

7. The apparatus according to claim 1, wherein said determination unit further determines based on the change of the search information whether or not image data corresponding to the change is excluded from search results which have already been displayed on the display unit, and
when said determination unit determines that the image data is excluded from the search results, said display control unit controls the display unit to display information indicating that the image data is excluded from the search results.

8. The apparatus according to claim 1, wherein said storage unit further stores previous search conditions accepted by said input acceptance unit, and
when search information, which is to be referred to when said search unit conducts a search based on the previous search condition stored in said storage unit, has been changed, said determination unit further determines that the change is notified.

9. The apparatus according to claim 1, further comprising:
a communication unit configured to communicate with a user apparatus via a network,
wherein said communication unit functions as said input acceptance unit by receiving a search condition of the image data via the network, and
said communication unit functions as said display control unit by transmitting display information of search results to the user apparatus so as to control the display unit included in the user apparatus to display the search results.

10. A control method of a data search apparatus for searching image data, comprising:
an input acceptance step of accepting an input of a search condition of image data;
a search step of searching for image data related to the search condition using search information of image data stored in a storage unit;
a display control step of controlling a display unit to display a list of images for selecting a desired image so as to edit the search information based on image data searched in the search step;
a detection step of detecting whether or not search information corresponding to each of the image data displayed on the display unit has been changed; and
a determination step of determining, based on relevance between the search condition accepted in the input acceptance step and the changed search information, whether or not to notify that the change has been made for the image data displayed on the display unit corresponding to the search information, wherein the change of which has been detected.

11. A computer readable storage medium storing a program, the program comprising instructions, which when executed by a data search apparatus for searching image data, cause the apparatus to:
accept an input of a search condition of image data;
search for image data related to the search condition using search information of image data stored in a storage unit;
control a display unit to display a list of images for selecting a desired image so as to edit the search information based on searched image data;
detect whether or not search information corresponding to each of the image data displayed on the display unit has been changed; and
determine based on relevance between the search condition, the input of which is accepted, and the changed search information whether or not to notify that the change has been made for the image data displayed on the display unit corresponding to the search information, wherein the change of which has been detected.
